(19) United States
(12) Patent Application Publication
(10) Pub. No.: US 2009/0188284 A1
(43) Pub. Date: Jul. 30, 2009

(54) APPARATUS FOR IMMOBILIZING A VEHICLE

(76) Inventor: Dan MECHALCHUK, Royston (CA)

Correspondence Address: DAVIS & BUJOLD, P.L.L.C., 112 PLEASANT STREET, CONCORD, NH, 03301, US

(21) Appl. No.: 12/359,532

(22) Filed: Jan. 26, 2009

Related U.S. Application Data
(60) Provisional application No. 61/023,137, filed on Jan. 24, 2008.

(51) Int. Cl. B60R 25/00

(52) U.S. Cl. 70/225

(57) ABSTRACT

An apparatus for immobilizing a vehicle includes an assembly of components that clamp onto a vehicle wheel rim of a vehicle. The components are capable of being locked in the assembled state. A cable is provided having a first end and a second end. Both the first end and the second end of the cable are secured to the assembly. At least one of the first end or the second end is detachably secured to the assembly to enable the cable to be wrapped around parts of the vehicle and then secured to the assembly when the assembly is in the assembled state.

### FIELD

The present invention relates to an apparatus for immobilizing a vehicle that has uses in parking enforcement and in theft prevention.

### BACKGROUND

There have been a number of devices developed that are capable of immobilizing a vehicle. An example of such a device is U.S. Design Patent Des 419,424 (Holden).

### SUMMARY

There is provided an apparatus for immobilizing a vehicle which includes an assembly of two components capable of being locked in the assembled state, engaged with a vehicle tire rim. A cable is provided having a first end and a second end. Both the first end and the second end of the cable are secured to the assembly. At least one of the first end or the second end is detachably secured to the assembly to enable the cable to be wrapped around parts of the vehicle and then secured to the assembly when the assembly is in the assembled state.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an apparatus for immobilizing a vehicle.

FIG. 2 is a top plan view of the apparatus of FIG. 1.

FIG. 3 is a bottom plan view of the apparatus of FIG. 1.

FIG. 4 is a rear elevation plan view of the apparatus of FIG. 1.

FIG. 5 is a front elevation view of the apparatus of FIG. 1.

FIG. 6 is a right side elevation view of the apparatus of FIG. 1.

FIG. 7 is a left side elevation view of the apparatus of FIG. 1.

FIG. 8 is a detailed longitudinal section view taken across the locking mechanism of the apparatus of FIG. 1.

### DETAILED DESCRIPTION

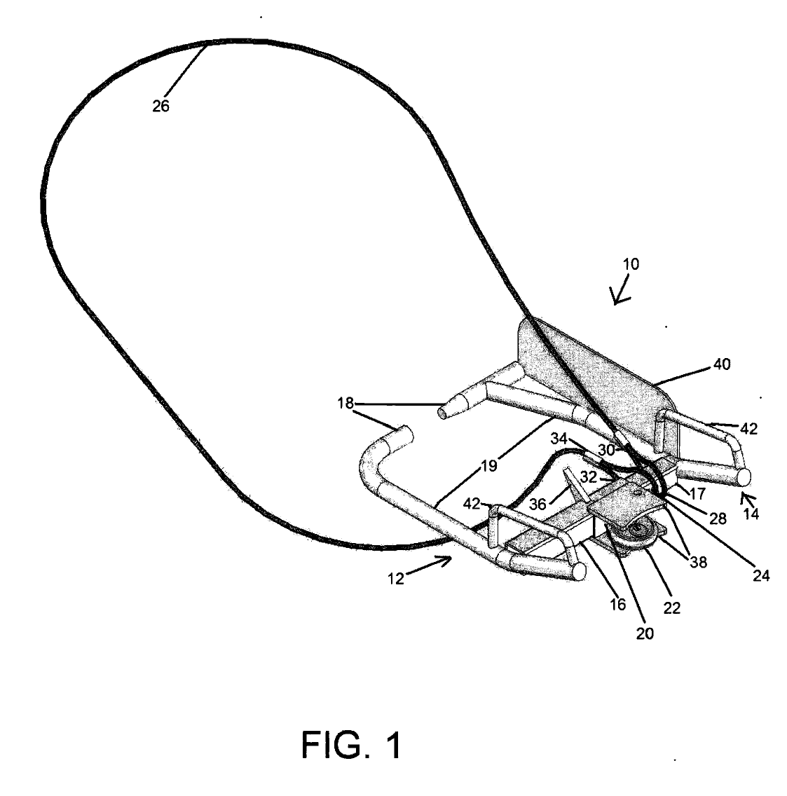

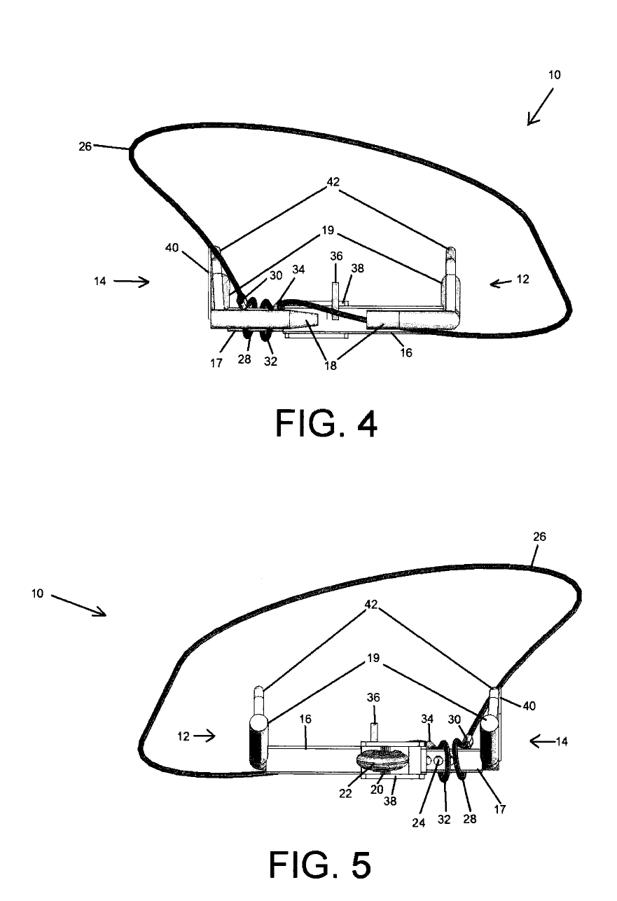

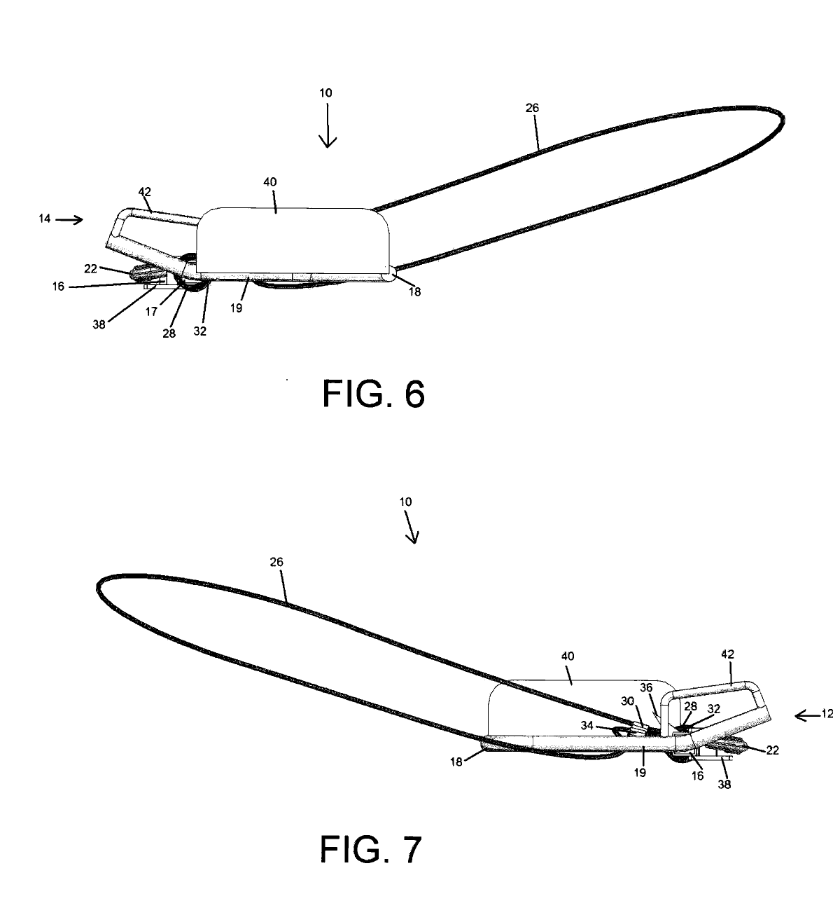

An apparatus for immobilizing a vehicle generally identified by reference numeral 10, will now be described with reference to FIG. 1 through FIG. 8.

Structure and Relationship of Parts:

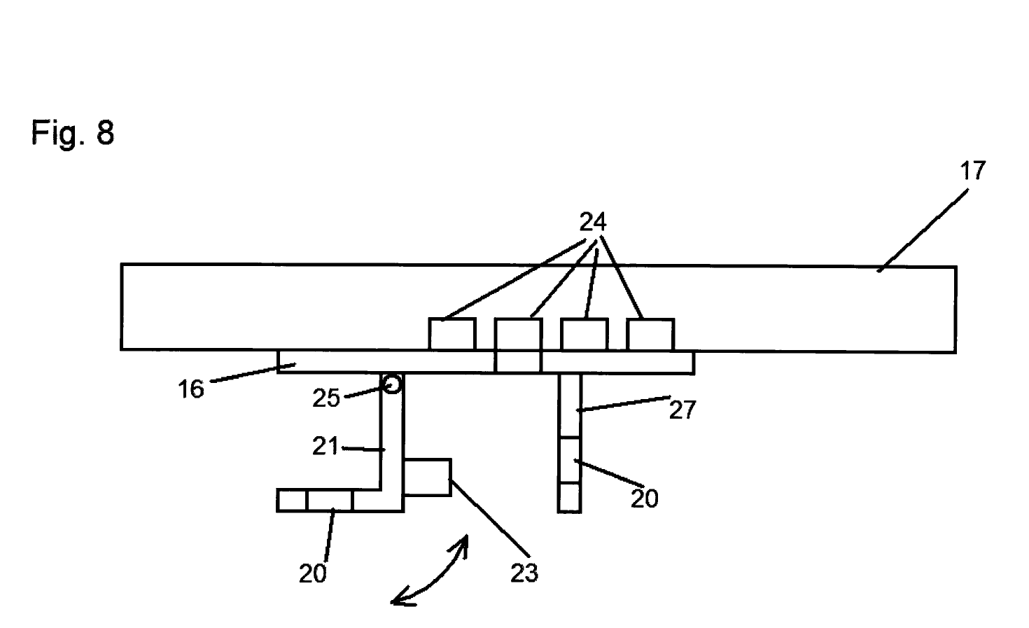

Referring to FIG. 1, apparatus 10 includes an assembly of components for assembly on a ground surface around a vehicle wheel. In the illustrated embodiment, this assembly of components includes a first component 12 and a second component 14. First component 12 includes a female telescopic member 16, a vehicle wheel rim engaging member 18 and a bridging member 19. Bridging member 19 connects female telescopic member 16 and vehicle wheel rim engaging member 18. Second component 14 includes a male telescopic member 17, a vehicle wheel rim engaging member 18 and a bridging member 19. Referring to FIG. 5, female telescopic member 16 of first component 12 telescopically receives male telescopic member 17 of second component 18. Referring to FIG. 8, male telescopic member 17 of second component 14 has a plurality of axially spaced female receptacles 24. Female telescopic member 16 of first component 12 has a movable member 21 that carries a male member 23. Movable member 21 is pivotally movable about pivot pin 25 between an engaged position in which male member 23 engages a selected one of female receptacles 24 and a disengaged position spaced from female receptacles 24. Movable member 21 has a hole 20 to accommodate a padlock 22. A fixed member 27 is also positioned on female telescopic member 16. Fixed member 27 also has a hole 20 to accommodate padlock 22. Axially female apertures 24 on male telescopic member 17 provide a variety of locking positions. Movable member 21 is maintained in the engaged position by inserting padlock 22 through hole 20 in movable member 21 and hole 20 in fixed member 27, to fix movable member 21 to fixed member 27. This locks first component 12 and second component 14 in a selected telescopic position with vehicle wheel rim engaging member 18 of first component 12 and vehicle wheel rim engaging member 18 of second component 14 acting together to clamp the vehicle wheel rim Referring to FIG. 1, a cable 26 is provided having a first endless loop 28 at a first end 30 and a second endless loop 32 at a second end 34. Both first end 30 and second end 34 of cable 26 are detachably secured to the assembly. This enables one of first end 30 or second end 34 to be detached and wrapped around or through parts underneath the vehicle, such as tie rods, springs or shock absorbers. The intent is to ensure that apparatus 10 is secured by cable 26 to the vehicle in a manner that makes it impossible to remove without cutting cable 26. Cable 26 is selected, so that it is extremely difficult, if not impossible, to cut with tools (such as a hack saw) that might be available to the average person. Of course, no system is tamper proof by persons having appropriate tools. Referring to FIG. 5, male telescopic member 17 of second component 14 is then extended through first endless loop 28 and second endless loop 32 of cable 26. Male telescopic member 17 of second component 14 is then telescopically engaged with female telescopic member 16 of first component 12 and locked in a selected telescopic position with padlock 22. First endless loop 28 and second endless loop 32 of cable 26 cannot come free from the assembly until first component 12 and second component 14 are separated, this serves to secure cable 26 to the assembly when the assembly is in the assembled state.

Referring to FIG. 1, there are a number of other features that can be added to apparatus 10 to further enhance its operation. It is preferred that a tire piercing wheel disabling member 36 be carried by first component 12 of the assembly to discourage movement of the vehicle wheel when the assembly is in the assembled state. As first component 12 and second component 14 can be separated if padlock 22 is removed, it is preferred that a lock guard 38 be carried by first component 12 of the assembly to guard where padlock 22 is positioned. Lock guard 38 prevents someone from striking padlock 22 with a hammer. As apparatus 10 could be removed by removing the vehicle wheel, it is preferred that a cut prevention guard 40 be supported by the second component 14 in a substantially vertical orientation to make it difficult if not impossible to cut through second component 14 for the purpose of releasing cable 26. It is also preferred that each of first component 12 and second component 14 be provided with a handle 42, to facilitate ease of handling and rapid positioning.

Operation:

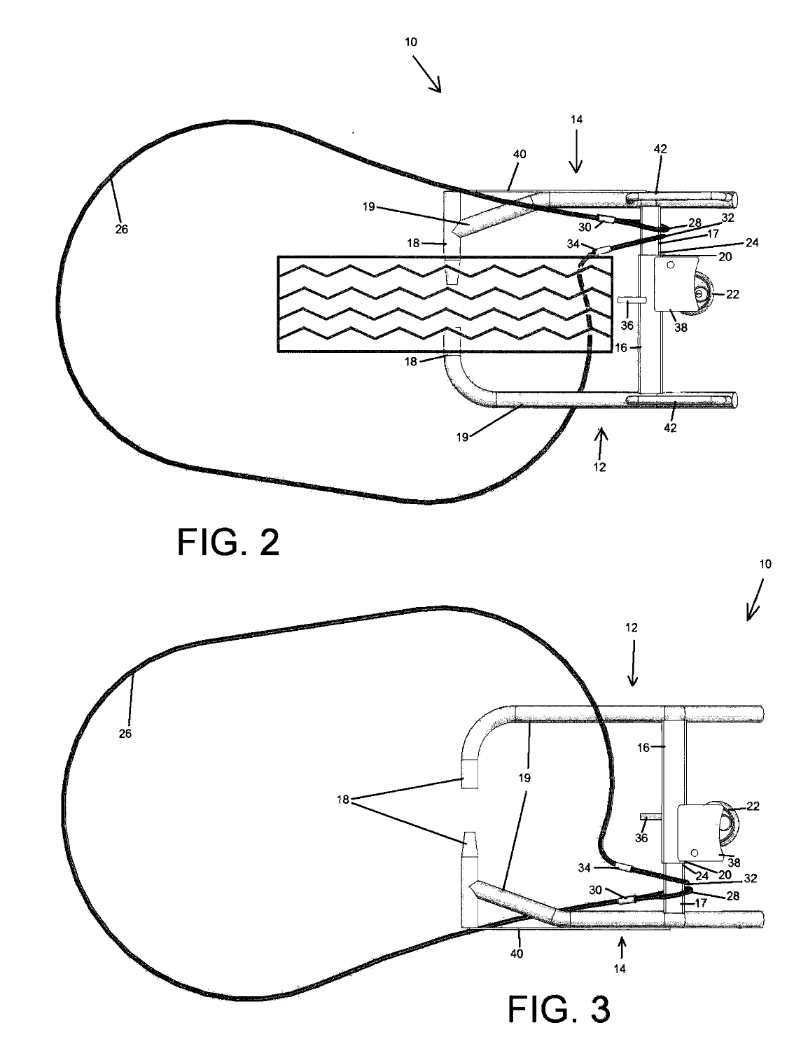

In operation, first component 12 and second component 14 are placed on a ground surface on either side of a vehicle wheel and manipulated into position using handles 42. Cable 26 is threaded through parts underneath the vehicle, such as a tie rod, spring, shock absorber or some other fixed portion under the vehicle. The intent is to secure apparatus 10 to the vehicle in a manner that cannot be released without cutting cable 26 or releasing cable 26 from apparatus 10. Referring to FIG. 5, male telescopic member 17 of second component 14 is then extended through first endless loop 28 and second endless loop 32 of cable 26. First component 12 and second component 14 are then assembled by inserting male telescopic member 17 of second component 14 into female telescopic member 16 of first component 12. Referring to FIG. 2, the correct telescopic positioning is achieved when vehicle wheel rim engaging member 18 of first component 12 and vehicle wheel rim engaging member 18 of second component 14 are engaged in recess of the vehicle wheel rim in such a manner that apparatus is secured to and cannot be separated from the vehicle wheel rim without separating first component 12 and second component 14. Movable member 21 is then pivoted about pivot pin 25 to an engaged position in which male member 23 engages a selected one of female receptacles 24. Movable member 21 is then maintained in the engaged position by inserting padlock 22 through hole 20 in movable member 21 and hole 20 in fixed member 27, to fix movable member 21 to fixed member 27 to maintain the relative telescopic positioning of first component 12 and second component 14. When assembled, first endless loop 28 and second endless loop 32 of cable 26 cannot come free from the assembly until first component 12 and second component 14 are separated, this serves to secure cable 26 to the assembly.

When the driver of the illegally parked vehicle returns, he will see apparatus 10 assembled around the vehicle wheel. It is intended that apparatus 10 be highly visible, and for that reason it is preferred that it be painted a bright colour. He will see vehicle wheel rim engaging member 18 of first component 12 and vehicle wheel rim engaging member 18 of second component 14 clamped onto the vehicle wheel rim of one of the wheels of his vehicle. He will see cable 26 extended under his vehicle and around or though parts of the vehicle in such a manner that apparatus 10 is “cabled” to his vehicle. Tire piercing wheel disabling member 36 carried by first component 12 immediately discourages any attempt at movement of the vehicle wheel for fear of damaging the vehicle's tires. Lock guard 38 renders futile or at least makes it difficult, for the driver to attempt to release the vehicle by damaging padlock 22 with blows from a hammer. Cut prevention guard 40 renders futile or at least makes it difficult, for the driver to attempt to release the vehicle by cutting through the metal tubing of second component 14 with a cutting tool, such as a hacksaw.

Advantages:

Apparatus 10, as described above, fits a wide range of sizes of vehicle wheels. It is comparatively light weight and relatively easy to install. If padlock 22 starts to show wear, it can be replaced. If cable 26 starts to show wear, it can also be replaced.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. An apparatus for immobilizing a vehicle, comprising:
an assembly of at least two components that engage a vehicle wheel rim of a vehicle;
locking means for locking the components in the assembled state; and
a cable having a first end and a second end, both the first end and the second end of the cable being secured to the assembly, at least one of the first end and the second end being detachably secured to the assembly to enable the cable to be wrapped around parts of the vehicle and then secured to the assembly when the assembly is in the assembled state.

2. The apparatus of claim 1, wherein a wheel disabling member is carried by one of the components of the assembly to discourage movement of the vehicle wheel when the assembly is in an assembled state;

3. The apparatus of claim 2, wherein the wheel disabling member is a tire piercing member.

4. The apparatus of claim 1, wherein there is a first component and a second component, the locking means comprises a first telescopic member on the first component that telescopically engages a second telescopic member on the second component, means being provided to maintain the first telescopic member and the second telescopic member in a selected telescopic position.

5. The apparatus of claim 4, wherein the second telescopic member has a plurality of axially spaced female receptacles and the first telescopic member has a movable member that carries a male member, the movable member being movable between an engaged position in which the male member engages a selected one of the female receptacles and a disengaged position spaced from the female receptacles, the movable member having a hole to accommodate a padlock, a fixed member being positioned on the first telescopic member, the fixed member having a hole to accommodate the padlock, the axially spaced female apertures on the second telescopic member providing a variety of locking positions, the movable member being maintained in the engaged position by inserting the padlock through the hole in the movable member and the hole in the fixed member to fix the movable member to the fixed member.

6. The apparatus of claim 5, wherein a lock guard carried by one of the components of the assembly guards where the padlock is positioned.

7. The apparatus of claim 1, wherein a cut protection guard is supported in a substantially vertical orientation by one of the components of the assembly.

8. The apparatus of claim 1, wherein each of the components of the assembly has a handle.

9. The apparatus of claim 1, wherein the assembly has two components, each of the components including a telescopic engagement member, a vehicle wheel rim engaging member and a bridging member for connecting the telescopic engagement member and the vehicle wheel rim engaging member.

10. The apparatus of claim 1, wherein each end of the cable is in the form of an endless loop.

11. An apparatus for immobilizing a vehicle, comprising:
an assembly of components for clamping a vehicle wheel rim on a vehicle, including a first component and a second component, the first component including a female telescopic member, a vehicle wheel rim engaging member and a bridging member for connecting the female telescopic member and the vehicle wheel rim engaging member, the second component including a male telescopic member, a vehicle wheel rim engaging member and a bridging member for connecting the male telescopic member and the vehicle wheel rim engaging member, the female telescopic member of the first component telescopically receiving the male telescopic member of the second component;
the male telescopic member of the second component has a plurality of axially spaced female receptacles and the female telescopic member of the first component has a movable member that carries a male member, the movable member being movable between an engaged position in which the male member engages a selected one of the female receptacles and a disengaged position spaced from the female receptacles, the movable member having a hole to accommodate a padlock, a fixed member being positioned on the female telescopic member, the fixed member having a hole to accommodate the padlock, the axially female apertures on the male telescopic member providing a variety of locking positions, the movable member being maintained in the engaged position by inserting the padlock through the hole in the movable member and the hole in the fixed member to fix the movable member to the fixed member, thereby locking the first component and the second component in a selected telescopic position with the vehicle wheel rim engaging member of the first component and the vehicle wheel rim engaging member of the second component acting together to clamp the vehicle wheel rim;
a cable having a first endless loop at a first end and a second endless loop at a second end, both the first end and the second end of the cable being detachably secured to the assembly to enable the cable to be wrapped around parts of the vehicle, the male telescopic member of the second component is then extended through the first endless loop and the second endless loop of the cable to secure the cable to the assembly when the assembly is in the assembled state.

12. The apparatus of claim 11, wherein a tire piercing wheel disabling member is carried by the first component to discourage movement of the vehicle wheel when the assembly is in the assembled state.

13. The apparatus of claim 11, wherein a lock guard carried by the first component of the assembly guards where the padlock is positioned.

14. The apparatus of claim 11, wherein a cut prevention guard is supported in a substantially vertical orientation by the second component.

15. The apparatus of claim 11, wherein each of the components of the assembly has a handle.
